(19) United States
(12) Patent Application Publication
(10) Pub. No.: US 2006/0255118 A1
(43) Pub. Date: Nov. 16, 2006

(54) Computer-readable medium for delivering account data to presentation instrument holders

(75) Inventor: James J. Waldron, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/129,563

(22) Filed: May 13, 2005

(51) Int. Cl. G06F 17/00

(52) U.S. Cl. 235/375

(57) ABSTRACT

A computer-readable medium has stored thereon presentation instrument account data relating to a particular customer. The computer-readable medium is deliverable via mail to a physical address of the customer. The presentation instrument account data comprises a selection of account data from a database of account data for a plurality of presentation instrument accounts, relating to a plurality of presentation instrument issuers and a plurality of customers. The presentation instrument data is selected according to criteria that defines specific account data that the customer requests to receive.

### CROSS-REFERENCES TO RELATED APPLICATIONS

This application is related to co-pending, commonly-assigned patent application Ser. No. 10/883,476 (Attorney Docket No. 020375-038520US), entitled Presentation Instrument Production Equipment and Methods,” filed on Jun. 30, 2004, by Pendergast, et al., the entirety of which is herein incorporated by reference for all purposes.

### BACKGROUND OF THE INVENTION

Embodiments of the present invention relate generally to data delivery systems. More specifically, embodiments of the invention relate to systems and methods for securely delivering account information to presentation instrument holders.

Presentation instruments (e.g., credit cards) are ubiquitous in modern society and are used frequently to, for example, settle purchase transactions and to obtain cash advances. Most presentation instrument holders (hereinafter “customers”) receive periodic account statements as paper documents sent through the postal system, while other customers receive electronically-delivered statements. Information from statements is used for personal bookkeeping, tax preparation, and the like. With the growing popularity of computerized personal accounting systems, however, many more customers would likely adopt electronic delivery systems, but for one or more concerns.

Likely one of the primary impediments to more customers adopting electronically-delivered account statements is concern over security. Despite significant advances in Internet security, some customers simply refuse to have highly personal and confidential data transferred through the Internet. Thus, these customers continue to receive account statements via normal postal channels.

Other customers may have bandwidth limitations. These limitations prevent the efficient receipt of large volumes of data electronically. Hence, these customers also continue to receive account statements via postal channels.

For at least the foregoing reasons, systems and methods are needed for delivering account data to presentation instrument holders.

### BRIEF SUMMARY OF THE INVENTION

Embodiments of the invention thus provide a computer-readable medium having stored thereon presentation instrument account data relating to a particular customer. The computer-readable medium is deliverable via mail to a physical address of the customer. The presentation instrument account data comprises a selection of account data from a database of account data for a plurality of presentation instrument accounts, relating to a plurality of presentation instrument issuers and a plurality of customers. The presentation instrument data is selected according to criteria that defines specific account data that the customer requests to receive. The computer-readable medium may have multimedia advertising stored thereon. The computer-readable medium may have account data for multiple customers stored thereon. The computer-readable medium may be CD ROM, DVD, USB drive, floppy disk, and/or the like. The computer-readable medium may have an application for viewing the account data stored thereon. The criteria may include a selection that defines two different accounts of the customer.

In other embodiments, a computing system programmed to deliver presentation instrument account data to a customer includes an interface to a computer of the customer, which interface is configured to receive from the customer a request to receive the account data. The request includes criteria that defines specific account data that the customer requests to receive. The system also includes a database at which is stored account data for a plurality of presentation instrument accounts, relating to a plurality of presentation instrument issuers and a plurality of customers, and a decisioning system that selects the specific account data based on the criteria from the request. The system also includes a production system configured to write the specific account data to a computer-readable medium and direct the computer-readable medium to a physical address of the customer. The criteria may include a selection that defines two different accounts of the customer. The criteria may include a selection of specific categories of transactions. The criteria may include a specific period of time. The computer-readable medium may be CD ROM, DVD, USB drive, floppy disk, and/or the like. The production system may be configured to write advertising to the computer-readable medium.

In still other embodiments, a method of delivering presentation instrument account data to a customer includes, at a host computer systems operated by a presentation instrument transaction processor, receiving a request from the customer to receive account data relating to at least one account of the customer. The method also includes producing a computer-readable medium having the requested account data and mailing the computer-readable medium to the customer. The request may include criteria that defines the account data. The criteria may include a selection that defines two different accounts of the customer. The criteria may include a selection of specific categories of transactions. The criteria may include a specific period of time. The computer-readable medium may be CD ROM, DVD, USB drive, floppy disk, and/or the like. The computer-readable medium may include an application for viewing the account data. The computer-readable medium may include multimedia advertising.

### BRIEF DESCRIPTION OF THE DRAWINGS

A further understanding of the nature and advantages of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 illustrates an exemplary system according to embodiments of the invention.

FIG. 2 illustrates an exemplary method according to embodiments of the invention, which method may be implemented in the system of FIG. 1.

FIGS. 3A-B illustrates exemplary screen displays though which a customer may interact with the host computer system of FIG. 1.

FIG. 4 illustrates an exemplary screen display through which the customer may interact with the computer-readable medium of FIG. 1.

### DETAILED DESCRIPTION OF THE INVENTION

Presentation instrument processing services are often performed by a processing entity (hereinafter “processor”). In some cases, the processor is a third party who processes transactions for one or more presentation instrument issuers. The issuers (e.g., banks, retailers, and the like) are not necessarily related, although a particular customer may have one or more accounts with several issuers. Part of the account processing function is to deliver statements to customers. Such services are well known, an example of which is the service provided by FIRST DATA® of Englewood, Colo.

According to embodiments of the invention, a processor uses a host computer system to process presentation instrument transactions and maintain customer accounts. In some embodiments, customers may elect to receive statements or other account information delivered via a computer-readable medium transmitted through postal channels. Such media may include optical disk (e.g., CD ROM disk, DVD disk), solid state memory device (e.g., USB drive), magnetic memory (e.g., floppy disk), and/or the like.

In some embodiments, the customer elects to receive the computer-readable medium (hereinafter “disk”) by accessing the processor's host computer system via a personal computer or other computing device. The interaction may include providing criteria used to select the specific information to be received on the disk. For example, the customer may select to receive information relating to a specific account or accounts, a specific time period, specific categories or transactions, and/or the like.

Thereafter, the processor uses the criteria to extract selected data from a database of transaction information and write the information to a disk. The processor then delivers the disk to the customer.

The disk may be password protected or otherwise secured to prevent unauthorized access. The disk may include application software that allows the customer to view the data. In some embodiments, the data may be downloaded to any of a number of different personal accounting programs. The disk also may include advertising or third party applications. Many other examples are possible. In some cases, a single disk may include account information for a number of different presentation instrument accounts, relating, for example, to a business that issues cards to employees. Many other possibilities will become apparent to those skilled in the art in light of this disclosure.

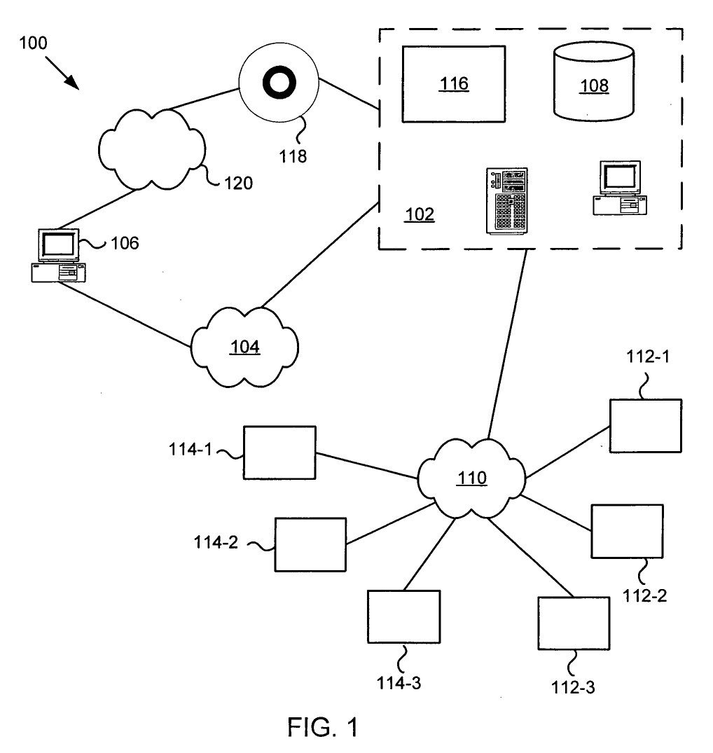

Having described embodiments of the invention generally, attention is directed to FIG. 1, which illustrates an exemplary system 100 for delivering account information to customers according to some embodiments. It should be understood that, although the examples used herein relate to presentation instrument accounts, this is not a requirement. Other types of account information may be delivered to customers, as is apparent to those skilled in the art in light of this disclosure. For example, the system of FIG. 1 or similar systems according to other embodiments may deliver utility account information, telecommunication account information (e.g., cell phone, Internet Service Provider, etc.), mortgage information, and/or the like. Further, the system 100 of FIG. 1 is merely exemplary and should not be considered limiting. Those skilled in the art will realize equivalent systems in light of the disclosure herein.

The system 100 includes a host computer system 102. The host computer system 102 may include, for example, server computers, personal computers, workstations, web servers, and/or other suitable computing devices. The host computer system 102 includes application software that programs the host computer system 102 to perform one or more functions according to the present invention. For example, application software resident on the host computer system 102 may program the host computer system 102 to send account information to customers. The host computer system 102 may include one or more of the aforementioned computing devices, as well as storage devices such as databases, disk drives, optical drives, and the like. The storage device may include solid state memory, such as RAM, ROM, PROM, and the like, magnetic memory, such as disc drives, tape storage, and the like, and/or optical memory, such as DVD. The host computer system 102 may be fully located within a single facility or distributed geographically, in which case a network may be used to integrate the host computer system 102. Many other examples are possible and apparent to those skilled in the art in light of this disclosure.

The host computer system 102 is connected to a network 104 through which customers may interact with the host computer system using, for example, a customer computing device 106. The network 104 may be the Internet, an intranet, a wide area network (WAN), a local area network (LAN), a virtual private network, any combination of the foregoing, or the like. The network 104 may include both wired and wireless connections, including optical links. The customer computing device 106 may be a personal computer, workstation, server, personal digital assistant (PDA), cell phone, and/or the like.

The host computer system 102 also includes an account information database 108 at which account information for a plurality of customers is stored. In some embodiments, the account information is transaction information relating to presentation instruments.

The host computer system 102 also is connected to a transaction processing network 110. The transaction processing network may be a portion of the network 104 or may be a separate network. In a specific embodiment, the transaction processing network 110 is a presentation instrument processing network, which may be a branded network (e.g., the VISA® or the MASTERCARD® networks) or the like. The transaction processing network 110 connects issuers 112 (e.g., banks, retailers, and the like), which issue presentation instruments (e.g., credit cards, debit cards, or the like) to customers, to merchants 114 (e.g., retailers, service providers, and the like) and the host computer system 102.

When a customer uses his presentation instrument to purchase an item or service from a merchant 114, a record of the transaction is transmitted to the host computer system 102 via the financial processing network 110. The transaction record is thereafter used to settle the transaction in well known ways. Periodically, statements are processed and transmitted to customers.

According to embodiments of the present invention, the host computer system 102 also includes an interface 116 through which customers may interact with the host computer system. The interface 116 may be, for example, a web interface that allows customers to specify information to receive from the database 108. For example, a customer may request to receive all his statements for a period of time for a particular account. In response to the request, the host computer system may create a disk 118 that includes the requested information and mail the disk 118 to the customer through the postal system 120.

In a specific embodiment, the interface 116 may include a decisioning system such as the system more fully described in co-pending, commonly assigned U.S. patent application Ser. No. 10/883,476. A web server may work with the decisioning system to allow the customer to make selections from pick lists, drop down windows and the like, as will be described in more detail hereinafter. Once the customer makes the selections, the interface extracts the necessary information from the database and assembles it into a file for transmittal to the customer. As will be described in more detail hereinafter, the final delivery to the customer may include utilities for viewing the data, advertising, and the like.

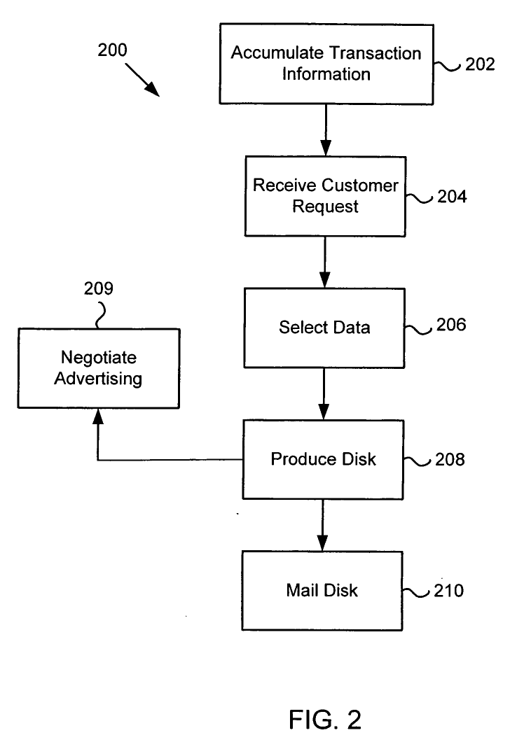

Having described an exemplary system according to embodiments of the invention, attention is directed to FIG. 2, which illustrates an exemplary method 200 according to embodiments of the invention. The method 200 may be implemented in the system 100 of FIG. 1 or other suitable system. It should be noted that the method 200 is merely exemplary of a number of possible embodiments. Other embodiments may include more, fewer, or different steps than those illustrated and described here. Further, other methods according to the invention may traverse the blocks in orders other than that illustrated and described here.

The method begins at block 202 at which point transaction information is accumulated at the host computer system 102 and stored at the account information database 108. Transaction information can include any type of information relating to cards, including specific transactions with merchants, the goods or services purchased, account payments, cash advances, and the like. As mentioned previously, the stored information is used periodically to process account statements, according to predetermined schedules, which are then sent to customers. According to embodiments of the invention, however, the information is used in other ways.

At block 204, a customer request is received at the host computer system 102. The request relates to stored information that the customer wishes to receive. According to embodiments of the invention, the specific information the customer desires may be segmented in a nearly infinite number of permutations. In a specific embodiment, the customer transmits the request by using a customer computing device 106 to access the host computer system 102 via the network 104. In other embodiments, customers use wireless devices, telephone systems, voice response units, and/or the like to deliver the request.

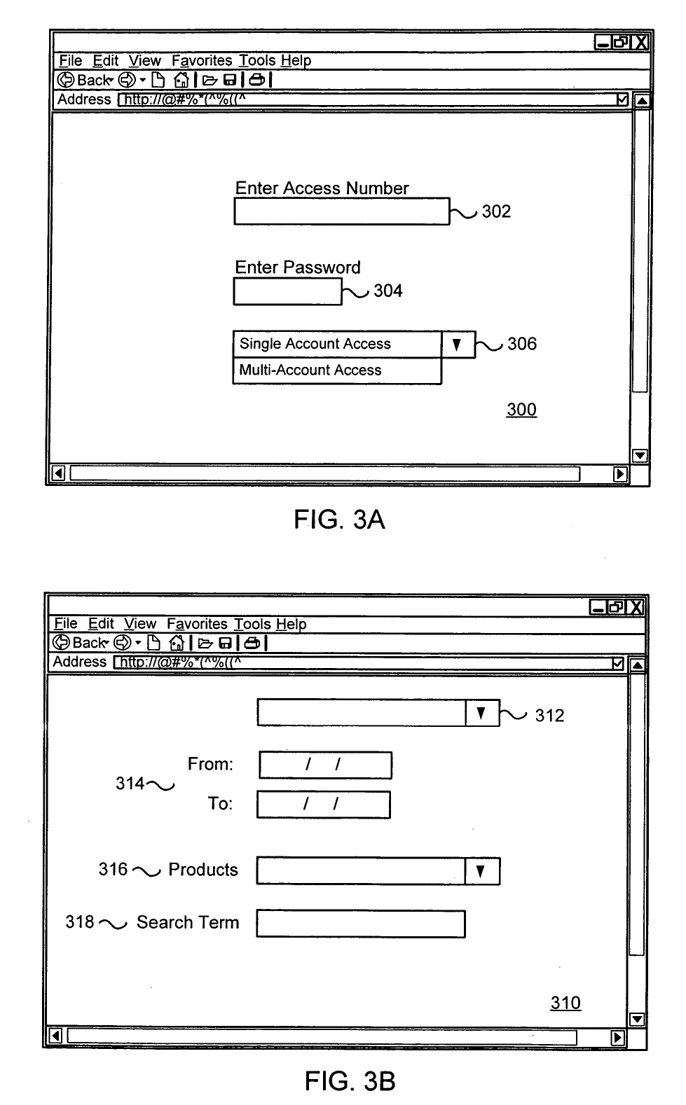

Also according to this specific embodiment, a web server of the host computer system 102 sends web pages to the customer computing device 106 through which the customer enters his request. For example, the screen display 300 of FIG. 3A illustrates one exemplary login screen. The login screen includes a field 302 for the customer to enter his account number or other userID, a password field 304, and a selection menu 306 for selecting the type of service the customer desires. The userID and password fields 320, 304 operate in ways well known to those skilled in the art. The selection menu 306 will be described in more detail below.

Using the selection menu 306, the customer can select from myriad services that may be implemented according to embodiments of the invention. In a specific example, the customer selects whether to access account information from a single account or from multiple accounts. If a customer owns several accounts, possibly even from different issuers, the customer may be able to access information from all the accounts. Or, if the customer is a business owner, the customer may have many employee accounts relating to employees for which the business owner customer desires to obtain information. Many such examples are possible.

Once the customer gains access through the first screen display, the customer is taken to a second screen display 310, such as that shown in FIG. 3B. Using the screen display 310, a customer may further specify his request. The screen display 310 may include, for example, a pick list menu 312, a date range field 314, a product category menu 316, a search field 318, and other similar fields. For example, a customer uses the pick list menu 312 to specify one or more accounts from which to receive data. The customer uses the date range field 314 to specify a range of time from which to select the data. The customer may use the product category menu 316 to specify classes of products, specific sku#s, dollar amounts, and/or the like. Using the search field 318, the customer may enter specific search terms. Many other examples are possible, including, for example, menus for selecting specific merchants, specific dollar amounts or dollar amount ranges and/or the like. In this example, the customer may select CD or DVD, although many other examples are possible.

Returning to FIG. 2, the method continues at block 206, at which point the host computer system uses the information provided by the customer to select specific information from the database 108. The information may be selected in any of a number of ways. In a specific embodiment, this comprises using a decisioning system such as systems more fully described in previously-incorporated U.S. patent application Ser. No. 10/883,476.

Once the customer-requested information is selected from the database, the information is used to produce a disk which may be mailed to the customer. The disk may be any appropriate transportable media, including those media types previously described herein. The disk may include application software through which the customer may interact with the information. The disk may include advertising, which may be interactive, multimedia, still, pop up, and/or the like. Advertisers and the operator of the host computer system may pre-negotiate advertising at block 209. In some cases, the advertising may completely cover the cost of preparing and sending the information to customers.

This specific embodiment of a method concludes at block 210, at which point the disk is mailed to the customer via U.S. Mail or other postal delivery system. Those skilled in the art will appreciate, however, that this embodiment is merely exemplary and will recognize other embodiments in light of this disclosure.

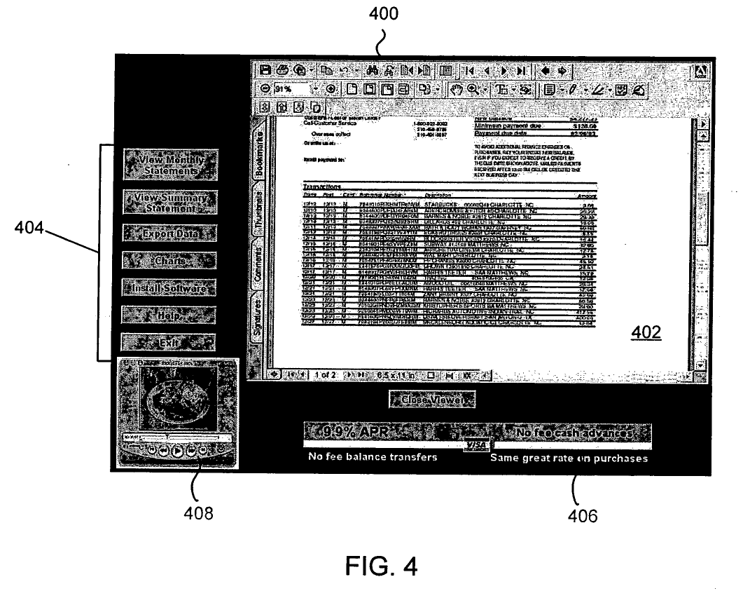

Attention is directed to FIG. 4, which illustrates an embodiment of a screen display 400 that a customer may encounter upon viewing the data on the disk. The screen display includes a viewing area 402 and buttons 404 for selecting various operations. The viewing area 402 may simply include an electronic document that includes the data. Such a document may be in any of a number of well known document formats, including .pdf, .txt, .doc, .xls or others. In some embodiments, documents are merely electronic copies of the customer's statements. In other embodiments, however, the viewing area 402 provides other views of the data or data segments.

The buttons 404 allow the customer to interact with the data and/or view the data in other ways. For example, buttons may allow the customer to simply view individual statements, install software to interact with the data, export the data to other applications, such as personal accounting software, and/or the like. Many other examples are possible.

As previously mentioned, data may be transmitted for a number of accounts. The accounts may all relate to a single customer or may relate to accounts to a number of customers in a common relationship, such as a business entity. In such cases, the screen display 400 may include buttons or other menu options for interacting with data for multiple accounts. A number of examples follow.

In a first example, a business owner may issue cards to a number of employees. At the end of the business' tax year, the business owner may request a disk having all transactions for all employee accounts. The business owner then may request reports, using tools provided on the disk, to obtain, for example, a report of travel expenses for the tax year, a report of entertainment expenses, a report of all charges totaling more than $2,000, and any of a number of other reports.

In another example, a customer has a number of cards issued by different entities, the transactions for which are all processed by the same entity. Thus, a transaction database of the processor stores all the information for the customer's accounts. The customer may request a disk having all transaction data for each account for a period of time. Upon receiving the disk, the customer has immediate access to the requested data in any of a number of different report formats. For example, the customer may run reports that chart spending trends over number of periods, spending by category, or even search for transactions for a specific product by SKU#. Many other examples are possible.

The screen display 400 also may include advertising. Advertising may include banner ads 406, multimedia ads 408 and/or the like. Ads may link to web sites, execute other applications, and/or the like, as is apparent to those skilled in the art.

Having described several embodiments, it will be recognized by those of skill in the art that various modifications, alternative constructions, and equivalents may be used without departing from the spirit and scope of the invention. Additionally, a number of well known processes and elements have not been described in order to avoid unnecessarily obscuring the present invention. For example, those skilled in the art know how to arrange computers into a network and enable communication among the computers. Additionally, those skilled in the art will realize that the present invention is not limited to data relating to presentation instrument accounts. For example, embodiments of the invention may relate to other types of accounts such as utility accounts, mortgage accounts, and/or the like. Accordingly, the above description should not be taken as limiting the scope of the invention, which is defined in the following claims.

1. A computer-readable medium having stored thereon:
presentation instrument account data relating to a particular customer;
wherein the computer-readable medium is deliverable via mail to a physical address of the customer, wherein the presentation instrument account data comprises a selection of account data from a database of account data for a plurality of presentation instrument accounts, relating to a plurality of presentation instrument issuers and a plurality of customers, and wherein the presentation instrument data is selected according to criteria that defines specific account data that the customer requests to receive.

2. The computer-readable medium of claim 1, wherein the computer-readable medium also has multimedia advertising stored thereon.

3. The computer-readable medium of claim 1, wherein the computer-readable medium has account data for multiple customers stored thereon.

4. The computer-readable medium of claim 1, wherein the computer-readable medium comprises a selection for the group consisting of CD ROM, DVD, USB drive, and floppy disk.

5. The computer-readable medium of claim 1, wherein the computer-readable medium also has an application for viewing the account data stored thereon.

6. The computer-readable medium of claim 1, wherein the criteria includes a selection that defines two different accounts of the customer.

7. A computing system programmed to deliver presentation instrument account data to a customer, comprising:
an interface to a computer of the customer, wherein the interface is configured to receive from the customer a request to receive the account data and wherein the request includes criteria that defines specific account data that the customer requests to receive;
a database at which is stored account data for a plurality of presentation instrument accounts, relating to a plurality of presentation instrument issuers and a plurality of customers;
a decisioning system that selects the specific account data based on the criteria from the request; and
a production system configured to write the specific account data to a computer-readable medium and direct the computer-readable medium to a physical address of the customer.

8. The system of claim 7, wherein the criteria includes a selection that defines two different accounts of the customer.

9. The system of claim 7, wherein the criteria includes a selection of specific categories of transactions.

10. The system of claim 7, wherein the criteria includes a specific period of time.

11. The system of claim 7, wherein the computer-readable medium comprises a selection for the group consisting of CD ROM, DVD, USB drive, and floppy disk.

12. The system of claim 7, wherein the production system is further configured to write advertising to the computer-readable medium.

13. A method of delivering presentation instrument account data to a customer, comprising:
at a host computer systems operated by a presentation instrument transaction processor, receiving a request from the customer to receive account data relating to at least one account of the customer;
producing a computer-readable medium having the requested account data; and
mailing the computer-readable medium to the customer.

14. The method of claim 13, wherein the request includes criteria that defines the account data.

15. The method of claim 14, wherein the criteria includes a selection that defines two different accounts of the customer.

16. The method of claim 14, wherein the criteria includes a selection of specific categories of transactions.

17. The method of claim 14, wherein the criteria includes a specific period of time.

18. The method of claim 13, wherein the computer-readable medium comprises a selection for the group consisting of CD ROM, DVD, USB drive, and floppy disk.

19. The method of claim 13, wherein the computer-readable medium includes an application for viewing the account data.

20. The method of claim 13, wherein the computer-readable medium includes multimedia advertising.
